(19) United States
(12) Patent Application Publication
(10) Pub. No.: US 2005/0252924 A1
(43) Pub. Date: Nov. 17, 2005

(54) Tablet dispenser

(76) Inventors: Wolfgang Pieper, Waldstetten (DE); Christian Neidlinger, Stuttgart (DE); Matthias Strobel, Schwabisch Gmund (DE)

Correspondence Address: KRIEGSMAN & KRIEGSMAN, 665 FRANKLIN STREET, FRAMINGHAM, MA, 01702, US

(21) Appl. No.: 10/486,668

(22) PCT Filed: Apr. 22, 2003
(86) PCT No.: PCT/EP03/04159

§ 371 Date: Aug. 19, 2004

(30) Foreign Application Priority Data
Apr. 22, 2003 (DE) 102 17 929.8

(51) Int. Cl. G06F 17/00; G04B 47/06; G07F 11/66; G07F 11/00

(52) U.S. Cl. 221/25; 700/231; 700/244; 368/11; 221/7; 221/2

(57) ABSTRACT

The present invention relates to an apparatus (1, 1′) for dispensing tablets, also in the form of pills, dragees or the like, having means for holding a blister pack (20), means for pushing out a tablet (21) from the blister pack and also means for setting taking times and means for displaying taking times. The invention provides for the apparatus (1, 1′) to have a bottom part (11, 101) and a lid (12, 102), removably connected to the bottom part (11), for holding the blister pack (20) and also having means (18, 43) for pushing out the tablets (21) from the blister pack (20), the arrangement of the means (18, 41) being matched to the arrangement of the tablets (21) in the blister pack (20) which is to be held. The present invention also relates to a lid (12, 102) and to a bottom part (11, 101) for such an apparatus.

The present invention relates to an apparatus for dispensing tablets, also in the form of pills, dragees or the like, having means for holding a blister pack, means for pushing out a tablet from the blister pack and also means for setting taking times and means for displaying taking times.

An apparatus of the generic type is known from DE 198 36 100 A1. This known apparatus has a holding part for holding a blister pack and a lid part. At the level of the tablets held in the blister pack, the holding part and the lid part are provided with openings through which the tablets can be pushed out. The apparatus is provided with a programmable electronic timer which can be used to activate an optical signal at the time for taking medicaments. For this purpose, every opening in the lid part of the apparatus has its own associated light-emitting diode which lights up at the time at which it is intended that medicaments be taken.

In the case of this apparatus of the generic type, the arrangement of the openings in the holding part and the lid part needs to be matched precisely to the respective blister pack, which is a complex matter in terms of production technology. In addition, assigning a respective light-emitting diode for each opening requires complex electronic equipment.

The object of the present invention is thus to provide an apparatus of the aforementioned type which is easier and less expensive to produce both from the point of view of production technology and electronic equipment.

The solution is an apparatus having the features of claim 1. The invention thus provides for the apparatus to have a bottom part and a lid, removably connected to the bottom part, having means for pushing out the tablets from the blister pack, the arrangement of the means being matched to the arrangement of the tablets in the blister pack which is to be held. This allows the apparatus in accordance with the invention to be matched easily/and inexpensively to any type of blister pack which is to be held, without having to manufacture the entire apparatus afresh. The individual apparatus matched to a particular blister pack can therefore be manufactured and offered less expensively. The bottom part and the lid can also be manufactured and sold separately.

Advantageous developments can be found in the subclaims. By way of example, the lid can have recesses with centered holes which hold pushbuttons such that they cannot be lost. This permits a comparatively low-wear form of the lid.

In addition, the bottom part or the top part can have at least one support onto which it is possible to place the blister pack or a grid or mesh and which supports the blister pack, so that the tablets can be pushed out without any difficulty. The grid or mesh has holes whose arrangement corresponds to the arrangement of the means. The grid or mesh can be arranged in the bottom part or in the top part.

In one particularly preferred development, the bottom part has a dispensing chute and a dispensing opening. This allows a tablet to be pushed out without any difficulty and taken without being lost. In addition, the fact that the underside of the blister pack is covered by the bottom part is more hygienic and ensures that no tablets are lost as a result of the blister pack being damaged.

The means preferably have at least one lamp element, so that visual signaling of which tablet needs to be pushed out is also possible. The means can therefore be made of a transparent, optically conductive plastic.

Advantageously, the bottom part or the top part is provided with a display device, preferably an LCD display or LED display. In addition, there can be at least one programming and/or display button. The button(s) can be used to program the date, the time and the taking cycle. Correct programming can be inspected using the display device. The latter can also emit visual signals when a tablet needs to be taken.

In another particularly preferred development, the inside of the lid is provided with a board having holes whose arrangement corresponds to the arrangement of the means. This board carries one or more circuits for programming the apparatus. The arrangement underneath the lid ensures that contact is made between the means, for example the pushbutton, and the board when a tablet is pushed out, so that the program registers the prescribed removal of a tablet. As an alternative, tablet removal can also be acknowledged manually, for example, using the keypad. In this case, the board can be provided both for programming the taking cycle for the tablets and for acknowledging tablet removal.

In one alternative, the board is provided just for acknowledging tablet removal, and the bottom part contains a further board for programming the taking cycle for the tablets, the two boards being in electrical contact with one another. In this way, the more complex electronics are provided as standard in the bottom part for all variants of the apparatus, and only the relatively simple electronics for acknowledging tablet removal are provided in the inter-changeable part of the apparatus, i.e. need to be manufactured individually for each type of blister pack. This makes manufacturing the apparatus less expensive overall.

Exemplary embodiments of the present invention are described in more detail below with reference to the appended drawings, in which:

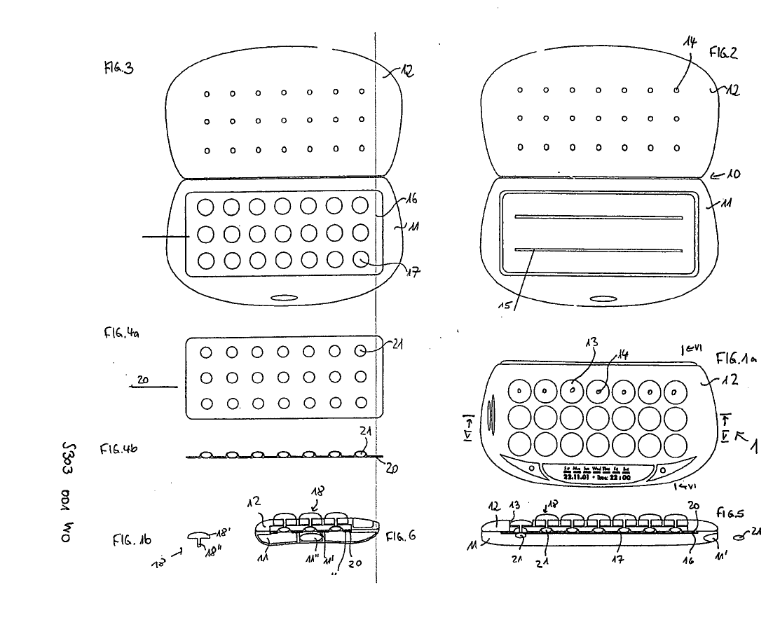

FIG. 1a shows a plan view of a first embodiment of the inventive apparatus in a schematic illustration, which is not to scale;

FIG. 1b shows a side view of a pushbutton for an apparatus as shown in FIG. 1a in a schematic illustration, which is not to scale;

FIG. 2 shows a plan view of the opened apparatus as claimed in claim 1 in a schematic illustration, which is not to scale;

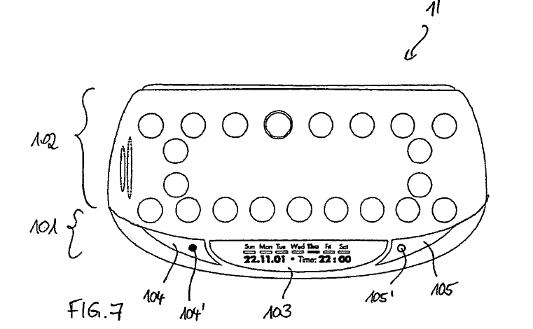

FIG. 3 shows a view as shown in FIG. 2, with an inserted underlay for the blister pack in a schematic illustration, which is not to scale;

FIG. 4a shows a blister pack in plan view in a schematic illustration, which is not to scale;

FIG. 4b shows the blister pack from FIG. 4a in a side view in a schematic illustration, which is not to scale;

FIG. 5 shows a section along the line V-V in FIG. 1;

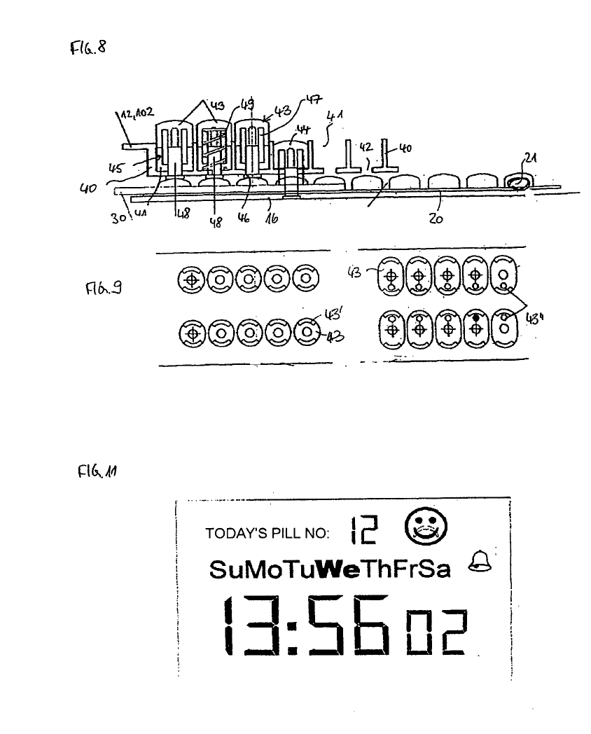

FIG. 6 shows a section along the line VI-VI in FIG. 1;

FIG. 7 shows a plan view of a second embodiment of the inventive apparatus in a schematic illustration, which is not to scale;

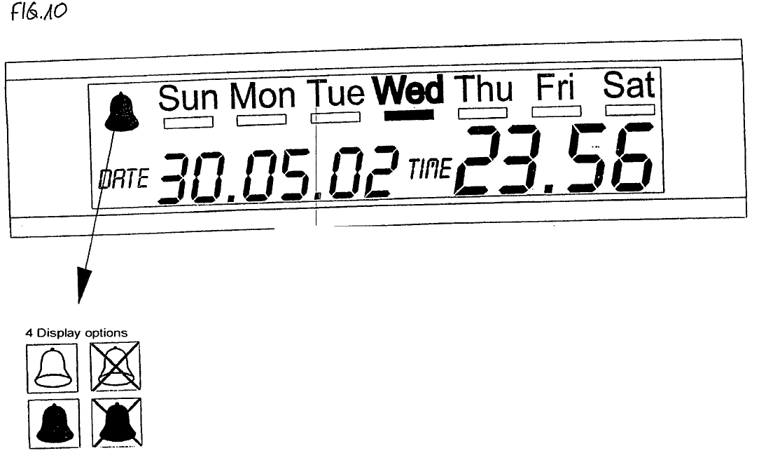

FIG. 8 shows a sectional illustration of a further embodiment of a lid for the inventive apparatus in a schematic illustration, which is not to scale;

FIG. 9 shows a plan view of the lid from FIG. 8 in a schematic illustration, which is not to scale;

FIG. 10 shows a detail view of a first embodiment of a display in a schematic illustration, which is not to scale;

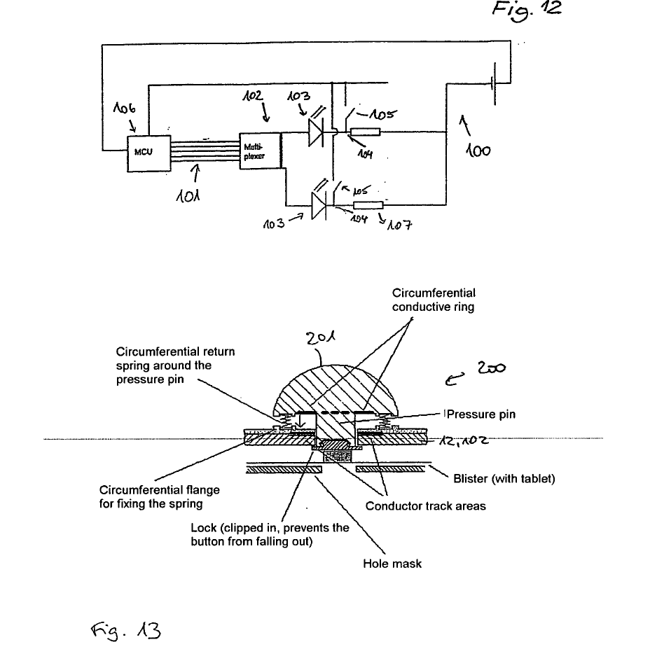

FIG. 11 shows a detail view of a second embodiment of a display in a schematic illustration, which is not to scale;

FIG. 12 shows a schematic illustration of a circuit for an inventive apparatus;

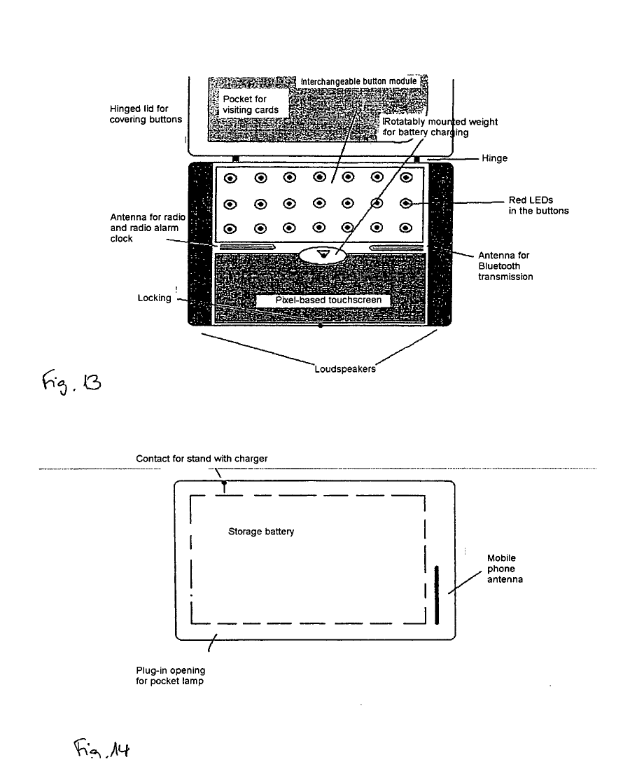

FIG. 13 shows a schematic illustration of the bottom part of a further embodiment;

FIG. 14 shows a schematic illustration of the lid in the embodiment from FIG. 13;

FIG. 15 shows a schematic illustration of a button with a feedback mechanism.

The embodiments of the inventive apparatus 1 which are shown in FIGS. 1a, 1b, 2, 3 and 7 comprise a housing 10 having a bottom part 11 and a lid 12 which are connected to one another by a film hinge. The bottom part 11 and the lid 12 are preferably made of a food-grade plastic, such as polystyrene, or acrylonitrile butadiene styrene (ABS) copolymers. The lid 12 and the bottom part 11 can be permanently sealed to one another, for example, using an ordinary tongue and groove seal. The lid 12 is removable and can be inter-changed for another lid having external contours which match the bottom part 11. The lid 12 has recesses 13 with centered holes 14. The recesses 13 hold pushbuttons 18 such that they cannot be lost, said pushbuttons having a head 18′ and a pin 18″ on the underside of the head 18′. The external diameter of the head 18′ is no larger than the internal diameter of the recess 13. The pin 18″ is held in the hole 14 such that it can move longitudinally.

The bottom part can, but does not have to, have supports 15 of any shape on its underside. These supports 15 can have a grid or mesh 16 with holes 17 placed removably on them. The holes 17 in the grid 16 are flush with the holes 14 in the lid 12 (when the lid is closed) and are congruent with the tablets 21 in a blister pack 20 (FIGS. 4a, 4b).

FIGS. 5 and 6 show an assembled apparatus 1. The grid or mesh 16 has been placed onto the supports 15. On top of that is the blister pack 20, which is covered by the lid 12 with the pushbuttons 18. It can be seen that the bottom part 11 is hollow and has a dispensing chute 11′ which leads to an exit opening 11″. Pressure on the pushbutton 18 pushes the pin 18″ onto the blister pack 20 at the level of a tablet 21. As a result of the pressure on the pin 18″, the tablet 21 is pushed out of the blister pack 20, drops into the cavity in the underside 11 and from there into the dispensing chute 11′, and can be shaken out of the apparatus 1 through the exit opening 11″.

What is not shown is that the inside of the lid 12 has a board, which likewise has holes corresponding to the position of the tablets 21 in the blister pack 20. This board carries programmable circuits which can be used to program the pattern for taking the tablets 21 and the time at which they are taken. The external contours of the board should correspond to the internal contour of the lid 12. The board contains recesses which latch (not shown) into spreading elements arranged in the lid 12. The board can be covered by a cover plate in order to prevent damage. The cover plate can likewise have recesses which latch (not shown) into the aforementioned spreading elements. The pushbuttons 18 can also be integrally formed in the cover plate or can be incorporated in another way such that they cannot be lost.

The pushbuttons 18 can be illuminated using light-emitting diodes mounted on the board which are either arranged next to the pushbuttons or are incorporated in the pushbutton 18 and allow it to be lit up if the pushbutton 18 is made of a transparent or optically conductive material, for example.

The structural design of the lid 12 is now such that the lid 12 and the board and the grid or mesh 16 form a unit. While the board is mounted directly on the under-side of the lid 12, the mesh or grid 16 can be inserted loosely into the bottom part. In addition, the lid 12 is mounted removably on the bottom part 11. According to the arrangement of the tablets 21 in the blister pack 20, the bottom part 11 can now have a lid 12 mounted on it with matching holes in the lid 12 itself and in the board, while a matching mesh or grid 16 is also delivered. The apparatus 11 can therefore be matched to various blister packs 20 in an extremely simple manner. It is merely necessary to ensure that the dimensions of the bottom part 11 are such that the apparatus 1 can hold blister packs 20 having different external contours or dimensions. FIG. 7 schematically shows an apparatus 1′ which has a different lid 12′, which is matched to a blister pack other than the one shown in FIG. 4a.

FIG. 7 also illustrates a further variant of the design of the inventive apparatus 1′. In this case, the apparatus 1′ is made up of a front part 101 and a rear part 102. The front part 101 comprises a housing for holding a further board for programming the alarm and the taking times for the tablets, with an LCD display 103 and four buttons 104, 104′, 105, 105′. The LCD display is preferably provided with a background illumination which can be provided in a manner which is known per se by means of LEDs or a lighting sheet or the like. The background illumination can be created such that it illuminates in the event of an alarm or in the event of one of the buttons being pressed and goes out again after a certain period of time after the alarm has been turned off or after the button has been pressed, for example, after 5 seconds. This front part 101 is identical for all blister packs 20.

As already described, the rear part 102 comprises a lid 12, 12′, a board 30 which is now used only for acknowledging removal of a tablet 21 when there is an alarm, possibly a grid or mesh 16, a dispensing chute 11′ and an exit opening 11″, and is mechanically and electrically connected to the front part 101 so that the two boards are in electrical contact. The front part then forms the underside 11 of the apparatus. The apparatus 1′ is programmed using the board provided in the front part 101. When a tablet 21 is removed, electrical contact is made between the pushbutton 18 and the board 30 arranged in the lid, so that the removal is registered and the information is passed on to the board held in the front part 101 and is registered by the program. The form of the button array, of the board 30 and possibly of the grid or mesh 16 on the rear part 102 is matched to the form of the respective blister pack 20 which is to be held.

The two boards can be supplied with power using button cells, for example. In this case, the front part preferably contains one or more button cells having the dimensions 11.6×5.4 mm, 125 mAh and 3 V voltage for the programming board, while the rear part 102 can contain one or more button cells having the dimensions 11.6×3.1 mm, 50 mAh and 1.5 V voltage for the acknowledgment board 30.

This means that an identical programming unit, provided in the front part 101, suffices for all blister packs 20. The rear part with the simpler board 30 for the acknowledgment is produced individually for each type of blister pack 20. This allows the apparatus 1′ to be matched to any type of blister pack 20 simply and inexpensively.

The overall design of the apparatus 1 has a comparatively flat form, with a physical height of between 20 and 30 mm, for example.

FIGS. 8 and 9 show a cross section and a plan view of a further exemplary embodiment of a lid 40. The lid 40 likewise has recesses 41 with centered holes 42 which are congruent with the arrangement of tablets 21 in a blister pack 20. The holes 42 contain pushbuttons 43 which have a head 44 and a shaft 45. The shaft 45 is made up of a sleeve 47 and a pin 48, with the pin 48 penetrating the hole 42 in longitudinally displaceable fashion. The underside of the shaft 45, below the lid 40, is provided with a pressure area 46 which rests on the packed tablet 21 in the blister pack 20. There can also be a spring 49, one end of which is fixed on the sleeve 47 and the other end of which is fixed in the recess 41.

When the pushbutton 43 is pressed, the pressure area 46 pushes the respective tablet 21 out of the blister pack 20, so that the tablet 21 drops into the cavity in the underside 11 of the apparatus 1, as shown in FIGS. 5 and 6, and can be removed via the dispensing chute 11′ and the dispensing opening 11″. When the pushbutton 43 is pressed, the spring 49 is compressed. On releasing the pushbutton 43 again, it returns to its starting position on account of the restoring force of the spring 49. The pushout depth of the pushbuttons 41 can be 4 mm, for example. Upon being pressed, the pushbutton 41 makes contact with the (acknowledgment) board 30, so that tablet removal is registered by the program.

FIG. 8 also shows that the (acknowledgment) board 30 is arranged directly below the lid 40. The board 30 has holes which are congruent with the arrangement of the tablets 21 in the blister pack 20. Below the board 30, the blister pack 20 is arranged such that the tablets 21 project through the holes in the board 30 and are in contact with the pressure areas 46 of the pushbuttons 41. Below the blister pack 20, the grid or mesh 16 which has already been described is arranged. To fill the apparatus, the blister pack 20 is placed onto the board 30 in such a way that the tablets 21 more or less “latch” into the holes in the board 30. The grid or mesh 16 is then placed onto the underside of the blister pack 20 and will become latched (not shown) to spreading elements provided on the underside of the lid 40 by means of further recesses provided in the grid or mesh 16, for example.

FIG. 9 shows a plan view of the embodiment of the lid 40 which is shown in FIG. 8, which reveals that the head 43 of the buttons 41 can be equipped with a luminous ring 43′ or a luminous dot 43″. If the head 43 is made of a colorless optically conductive plastic, the result of this is that the entire head 43 or the entire button 40 is lit up. Programming is carried out such that it is always precisely the head 43 of that button 40 which is to be pressed in the individual instance which is lit up.

FIGS. 10 and 11 show two embodiments of an LCD display for the inventive apparatus. The LCD display should contain: an alarm symbol such as a bell or a smiley, a time in hours and minutes, a date in day, month and possibly year, an indication of the seven days of the week, possibly in abbreviated form, and the current day of the week should be highlighted by underlining, bolder fonts and the like.

The alarm display can take the following form: when no alarm has been programmed, there is no display. Once the alarm has been programmed and activated, the outer contour of a bell or a smiley with a smiling face appears. When the alarm time has been reached, there appears a solid, possibly flashing bell symbol or a possibly flashing smiley with a sad face. In addition, it is possible to activate an audible signal in a manner which is known per se, using a piezoelectric element. When this signal has been silenced, the respective bell symbol or the respective smiley appears in dots or in dashes or crossed out. There can also be a further visual signal, namely the, possibly flashing, illumination of the button for the tablet which is to be pushed out. When tablet removal has been acknowledged via the (acknowledgment) board 30, the audible and visual signals are turned off, and the outer contour of the bell or the smiley with smiling face appears again. The various alarm signals can be in a continuously activated state up until acknowledgment; the audible signal and the illumination of the button can, in order to save power, be activated over a limited period of time, for example, between 1 and 5 seconds, and can be repeated until tablet removal is acknowledged, at certain intervals of time, for example, between 5 and 30 minutes.

By assigning the buttons 104, 104′, 105, 105′ at the programmer's discretion, it is possible to set the time, date, possibly the day of the week and also the taking cycle (time of the alarm, date of the alarm, possibly day of the week of the alarm). If a blister pack 20 which has been opened is inserted or following a change of battery, it is also possible to set the pushbutton which is to be pushed upon the next alarm.

The inventive apparatus 1 can also be varied in relation to the provision of additional functions. Exemplary embodiments in this regard will be described below.

Variant No 1

This embodiment is intended to furnish the inventive apparatus having the necessary functions. An example of this variant could take the following form:

The lid 12, 102 contains an exactly dimensioned compartment so as [lacuna) for holding the blister pack 20 in order to prevent the blister pack 20 from slipping. The grid or mesh 16 can be provided immovably in the lid 12, 102, for example can be fixed so as to be flush left without any play. The button lock is then provided not by means of the grid or mesh, but rather using a protective cover over the buttons. The protective cover is mounted on a hinge, for example, and covers the entire lid (not shown). The fact that the grid or mesh 16 is fixed means that a few millimeters of space are gained which can be used to configure the dispensing opening 11′ in funnel shape, which simplifies removal of the tablets 21; less shaking is required. If the intention is to insert a blister pack 20 having a different format, then in this exemplary embodiment both the lid 12, 102 and the grid or mesh 16 need to be renewed. The bottom part 11, 101 can be retained. This exemplary embodiment dispenses with protecting the blister compartment from unauthorized access.

A further simplification could involve the lamp means 43′, 43″ for displaying the button 18, 43 which is to be pushed being implemented using an LED next to the button. To extend the useful life of the battery, it is recommended that low current LEDs drawing a current of 2 mA be used. Particular recommendation is given to red LEDs on account of their high light output.

The pushout mechanism used is preferably the variant already described above (one pressure pin per tablet). As already explained above, the means 18, 43 should be designed such that pushing the button for alarm acknowledgment results in the associated LED circuit opening. An example of this is shown schematically in FIG. 15. What is involved is a button 200 which has a pressure pin and a top side 201. Incorporated between the pressure pin and the top side 201 is a circumferential, conductive ring. The pressure pin projects through the lid 12, 102 and its free end is prevented from falling out by means of a clipped-in latch. The pressure pin is directly opposite the blister placed on the hole mask or directly opposite a tablet held in this blister. The lid 12, 102 incorporates conductor track areas opposite the circumferential ring. The top side 201 is spaced apart from the lid 12, 102 by means of a circumferential return spring, so that there is no possibility of unintentional contact between the circumferential ring and the conductor track areas. The spring is fixed using a circumferential flange, for example. If the top part 201 is now pushed in order to push out the tablet from the blister, then electrical contact is made between the circumferential ring and the conductor track areas. This results in a signal which the electronics understand to be an alarm acknowledgment (the alarm has been sensed and the tablet has been removed). This ends the alarm signal for the tablet removal which is required at this time, since there has been a response to the alarm.

Instead of circumferential rings and circumferential springs, noncircumferential conductive sub-areas and individual springs are naturally also conceivable.

This exemplary embodiment dispenses with enabling individual buttons because this would result in higher costs for development and production and would also entail higher power consumption on account of the apparatus for locking and unlocking the individual buttons.

Since most microcontrollers are not yet directly USB compatible, the use of a serial adapter cable should be considered, with a compact connector on the apparatus 1 and a conventional serial connector on the external input device. When using a USB compatible MCU, it is naturally also possible to use a USB interface.

In principle, a great diversity of microcontrollers can be selected. These involve an apparatus which is installed on a board and comprises a memory chip, a chronometer and possibly a voltage sensor. The memory chip stores the necessary software program and the taking plan.

A microcontroller which has a sufficient number of I/O pins and also allows a supply of power to the LEDs in the top shell is preferred. The number of pins required is ultimately also dependent on what other components are used, e.g. what display. A rough estimation results in the following exemplary requirement, however:

To actuate up to 31 buttons, 6 pins are required (5 for supplying power via a multiplexer, one pin for polling whether the corresponding button has been pushed). The basic idea of the circuit is illustrated in FIG. 12. The five output lines 101 from the microcontroller are used for supplying power to the LEDs 103. For space reasons, only two LEDs are shown by way of example. In addition, they send a multiplexer 102 the information regarding which button needs to be actuated. The five lines can be used to implement 2⁵=32 states. Since no current flows in the state 00000, however, no more than 31 diodes can be actuated in this manner. The multiplexer 102 ensures that the incoming current flows only through that diode which is actually intended to be addressed for a definite alarm. The MCU's output voltage drops across the diode and the downstream resistor 107. At the branching points 104, a voltage is therefore tapped off which is part of the output voltage from the microcontroller. Pressing the tablet pushout button closes the associated switch 105, which means that the voltage tapped off at 104 is now applied to the input 106 of the microcontroller. It is assumed that the input pin at the controller end has a sufficiently high input resistance. In this way, the microcontroller learns that the button has been pressed, and is able to turn off the alarm and the diode. A problem which should be remembered in this context is that the voltage 104 may not be high enough to be clearly identified as a “1” signal. Should this situation arise, the chosen input pin needs to be an A/D converter which is also able to identify partial voltages. In the case of low current LEDs, the current drawn is normally 2 mA, otherwise is typically 10 mA. A further pin is used for actuating the piezoelectric bleeper. Three pins are required for the three pushbuttons for the purpose of manual programming, 2 further pins for actuating the serial interface. The number of pins for the LCD display is ultimately dependent on the model chosen (a typical display from the Internet needs 11 pins, for example). Two further pins are required for connecting an external crystal (dimensions approximately 8*3.7*1.8 mm). This would result in a need for approximately 23 pins. When selecting the microcontroller, it should be remembered that the total current drawn by the apparatus on average over time should not exceed a threshold value ensuring a battery useful life of approximately 1 year (approximately 300 mA with miniature batteries). One microcontroller which meets the aforementioned requirements extremely well and is also extremely cost-effective is the model PIC16F871 from Microchip Technology. A model which is likewise suitable and is also more powerful is the PIC18F4220, which is not yet available on the market, however. This has an inbuilt sensor for measuring the battery voltage, said sensor being able to cover the entire operating voltage range. In addition, this model permits rapid, software controlled alignment of the oscillator frequency. The accuracy of the internal oscillators is only 1%. This device could also be in the form of an extremely compact QFN package.

One particularly simple refinement is software controlled disconnection of the manual control part, for example, using a code sent via the interface by the doctor. If the microcontroller used supports this, it is sufficient to set a lock bit for an EEPROM data store as appropriate following correct code input.

To store the data and times input by the user, an inexpensive FLASH memory is suitable, for example, which can also be incorporated in the microcontroller. Alternatively, a somewhat more expensive EEPROM memory is also conceivable. Both types of memory hold the stored data, even in the event of a power failure, which allows the battery to be changed without any difficulty.

To control the possibly flexible alarm function, commercially available software suffices. Sound is generated by a piezoelectric bleeper, for example. Alarms can be acknowledged by virtue of the pushing of the button applying a voltage to a defined pin on the microcontroller.

Power is supplied using commercially available batteries. However, preference is given to a useful life of approximately one year, which means that miniature batteries (for example two 1.5 V miniature batteries) are preferred over button cells. However, this requires the bottom part 11, 101 to be correspondingly adjusted to be able to hold the batteries. If the LCD display is not lowered, this results in additional stowage for the batteries. Likewise suitable, but having a shorter useful life, are microbatteries (AAA size), which are smaller than miniature batteries. If the microcontroller used does not have an integrated voltage sensor, it is necessary to use an additional voltage sensor in order to monitor the performance of the batteries. Data storage when changing batteries involves the use of the microcontroller's EEPROM.

The clock can be controlled using the microcontroller's timer. In order to be able to achieve better accuracy, an external crystal can be used as a timer in normal operation.

For the display function, a simple LCD display, possibly even just an LED display, is chosen. These displays are inexpensive and require only little current.

Variant No 2

This variant No 2 of the exemplary embodiment corresponds to variant No 1 described above, but contains further functions which will be explained below.

The blister compartment can be protected from unauthorized access using a simple lock. One conceivable solution would be locks such as are used in moneyboxes, since these take up little space for themselves. As an energy source, environmentally friendly storage batteries are preferred over conventional batteries. Time measurement can be supported by radio alignment with a time transmitter (radio clock). As an additional illumination component, a light bulb can be accommodated on the outside of the lid 12, 102. This can be used as a key-finder or else as a reading lamp for emergencies, for example.

The lid 12, 102 or the bottom part 11, 101 can be provided with a plug apparatus which allows design applications to be added, such as image plates for collection, differently colored covers, for a key fob and the like.

Inside the lid 12, 102, a compartment for holding visiting cards or an emergency reserve of money can be accommodated above the buttons. One simple solution to this is a material pocket with stretch rubber for wear, as can occasionally be found on the rear of car seats. This can be firmly bonded by one or more of its edges to the inside of the lid 12, 102.

Variant No 3

Variant No 3 can have a few additional functions more than variant No 2 described above.

Variant No 3 is preferably made from high-value materials and has a representative appearance. By way of example, it would be conceivable for the outer casing to be produced in stainless steel or using a wood application. The overall device is larger in the luxury variant than in the other two cases on account of the numerous additional functions. Part of it is shown schematically in FIGS. 13 and 14.

So as not to have to replace the entire lid 12, 102 when changing medicaments, the lid can be designed such that the variable components are separated from the “constant components” to an even greater extent than when the bottom part 11, 101 and the lid 12, 102 were separated. To this end, a modular design of the lid 12, 102 is appropriate. This could take the following form:

A “button array” module is provided which comprises the pushout buttons 18, 43, the lamp elements 43′, 43″ and that part of the board which contains the top hole mask for guiding the pushout buttons 18, 43. A second module having the remaining components of the lid 12, 102 could contain the microprocessor, a display or touchscreen and also the possibly high-value casing (apart from in the immediate area of the buttons 18, 43). The modules are preferably designed such that they latch into one another. In this context, it is also possible to provide connectors for all the necessary electronic connections.

Illumination can be provided by lamp means 43′, 43″ such as LEDs in the button 18, 43 itself and not by lamp means 43′, 43″ next to the button 18, 43. The switching arrangement proposed for the low cost version can be retained in this case, it is just that the lamp means is now seated in the button and the current needs to be routed through the button via a contact.

Programming by the user can be carried out using a pixel-based touchscreen, which can simultaneously be used as a flexible display. The fact that the programming buttons are dispensed with means that the display can be of correspondingly larger design. For the purpose of rapid programming of taking plans wirelessly, a Bluetooth interface can be used. Sounds can be generated using small loudspeakers fitted on the sides.

For the purpose of supplying power, a storage battery preferably integrated into the bottom shell, for example the storage battery of a mobile telephone integrated in the inventive apparatus, can also be included. Charging is performed both using a stand with an integrated charger and by moving the device. The latter function is suitable only for supporting the actual timer operation by supplying power, however, and the current produced is not sufficient for the additional devices.

The rear of the bottom part 11, 101 can hold the fundamental components of a mobile telephone (storage battery, antenna, transmitter, etc.). However, the inventive apparatus' touchscreen can be used for operation. The mobile telephone's considerable trans-mission power means that it would be advisable to shield the microcontroller so that unintentional operating faults or even data changes can be prevented. The incoming and outgoing lines which penetrate the shield may need to have filters fitted to them in order to filter out the mobile radio frequencies. For the purpose of charging the storage battery, a charging station with a stand or a charging cable are suitable.

The inventive apparatus can also incorporate a radio. The loudspeakers for the radio can then be fitted to the side of the housing, while the electronics of the radio can be accommodated in the lid 12, 102. It is likewise possible to use the touchscreen for operation.

The pixel-based display can be designed such that it is suitable for displaying simple games. Games which are suitable for this are: Pacman, Tamagotchi, Tetris and others. As an additional lighting component, a pen-like pocket lamp can be plugged on at the side, in a similar manner to the special pen for a handheld computer.

The features of the individual variants are summarized again in the appended annex 1. Annex 2 lists these variants together with further implementation options in table form.

The features described for the various variants can naturally be combined with one another as desired.

### Summary of Subfunctions—Variant No 1

Blister held in an exactly shaped depression

Alignment with new blister format by changing the top shell

Indication of the button to be pushed by LED next to it

Precisely one pushout button is above each tablet

Buttons are locked using a cover above buttons

A tapered opening simplifies tablet removal

Manual programming is effected using 4 control buttons

The computer interface should be matched to the MCU, in this case a serial interface, for example

The taking plan is stored in the microcontroller's EEPROM

Conceivable controllers e.g. microchip PIC16F871/PIC18F4220

Software controlled locking of the manual control part

Alarm generation by means of piezoelectric bleeper

Alarm acknowledgment by contacts on the buttons

Power supplied using normal batteries (miniature, possibly micro)

Low battery warning function performed by the microcontroller (in connection with PIC 18F4220)

Data storage upon change of battery is ensured by EEPROM

Time measurement performed using the microcontroller's timer in connection with an external clock generator (on account of accuracy)

The time is displayed using a conventional LCD display (not pixel-based)

### Summary of Subfunctions—Variant No 2

Blister held in an exactly shaped depression

Lock to protect the blister compartment from access

Alignment with new blister format by changing the top shell

Indication of the button to be pushed by LED next to it

Precisely one pushout button is above each tablet

Buttons are locked using a cover above buttons

A tapered opening simplifies tablet removal

Manual programming is effected using 4 control buttons

The computer interface should be matched to the MCU, in this case a serial interface, for example

The taking plan is stored in the microcontroller's EEPROM

Conceivable controllers e.g. microchip PIC16F871/PIC18F4220

Software controlled locking of the manual control part

Alarm generation by means of piezoelectric bleeper

Alarm acknowledgment by contacts on the buttons

Power supplied using storage batteries (miniature, possibly micro)

Low battery warning function performed by the microcontroller (in connection with PIC 18F4220)

Data saved in the EEPROM when batteries changed

Time measurement performed using the microcontroller's timer

A receiver is used to request signals from time transmitters, and in this way the time is updated (automatic changeover to summer time, time updated following change of battery)

The time is displayed using a conventional LCD display (not pixel-based)

Interchangeable design applications plugged on

Material pocket on the inside of the hinged lid for visiting cards, money, etc.

Light bulb on the outside as emergency lighting

### Summary of Subfunctions—Variant No 3

Blister held in an exactly shaped depression

Lock to protect the blister compartment from access

Alignment with new blister format by changing the button array

Indication of the button to be pushed by LED in the button

Precisely one pushout button is above each tablet

Buttons are locked using a cover above buttons

A tapered opening simplifies tablet removal

Manual programming is effected using a touchscreen

Wireless data transmission using Bluetooth

The taking plan is stored in the microcontroller's EEPROM

Conceivable controllers e.g. microchip PIC18F4220

Software controlled locking of the manual control part

Alarm generation by means of active boxes

Alarm acknowledgment by contacts on the buttons

Radio integrated in the top shell with active boxes at the sides

Games function using the touchscreen (Tetris, Tamagotchi, Pacman)

Pocket lamp plugged on outside

Material pocket on the inside of the hinged lid for visiting cards, money

Power supplied using storage batteries (miniature, possibly micro)

Stand with charger

Charging upon movement by eccentric weight

Low battery warning function performed by the microcontroller (in connection with PIC 18F4220)

Data saved in EEPROM upon change of battery

Time measurement performed using the microcontroller's timer

A receiver is used to request signals from time transmitters, and in this way the time is updated (automatic changeover to summer time, time updated following change of battery)

All relevant information displayed using a pixel-based touchscreen

GSM mobile telephone in the bottom shell (operated using the touchscreen)

Basic functions

1. Holding compartment for the blister

| | | | | |
|---|---|---|---|---|
| 1.1. | 1.1.1. | 1.1.2. | 1.1.3. | 1.1.4. |
| Fixing of | Exactly | Pressure Holding | Displace- | |
| the blister | shaped | using a | in side | able side |
| | depression | spring | rails | walls |
| 1.2. | 1.2.1. | 1.2.2. | 1.2.3. | 1.2.4. |
| Holding of | Change of | Change | Change of | Change of |
| various | top shell | of | top shell | top shell |
| blister | (disengage | button | (unscrew | (hinge's |
| formats | clamp | array | hinge) | journal can |
| | apparatus) | only | | be |
| | | | | disengaged) |
| 1.3 | 1.3.1. | 1.3.2. | 1.3.3. | |
| Protection | Normal | With | Time-con- | |
| of blister | lock (as | code | trolled | |
| compartment | for a | card | opening | |
| from | moneybox) | | (by | |
| unauthorized | | | electro- | |
| access | | | magnet) | |

Basic functions

2. Pushout function

| | | | | | |
|---|---|---|---|---|---|
| 2.1. | 2.1.1. | 2.1.2. | 2.1.3. | 2.1.4. | |
| Display of | By LED | By | By | By routed | |
| present | next to | illumin- | display | light | |
| button | the | ation | of of the | | |
| | button | the | button | | |
| | | button | number | | |
| | | itself | | | |
| 2.2. | 2.2.1. | 2.2.2. | 2.2.3. | 2.2.4. | |
| Pushout | One | Total of | Servo- | With | |
| mechanism | ressure | one | motor(s) | force | |
| | pin per | movable | | trans- | |
| | button | pressure | | ducer | |
| | | pin | | (trans | |
| | | | | lation) | |
| 2.3 | 2.3.1. | 2.3.2. | 2.3.3. | 2.3.4 | |
| Button lock | | Cover | Displace- | Hole | Indi- |
| | above the | able hole | mask, | vidual | |
| | buttons | mask, | fixed | locking | |
| | | fixed | like a | of the | |
| | | using | carpet | buttons | pin) |
| | | pins | knife | (locking | |
| | | | blade | pin | |
| 2.4. | 2.4.1. | 2.4. | | | |
| Enabling of | Opening | Mechanical | | | |
| individual | of a lock | dis- | | | |
| buttons | by | engagement | | | |
| (only with | electro- | of the lock | | | |
| 2.3.4.) | magnet | (gearwheel) | | | |
| 2.5. | 2.5.1. | 2.5.2. | 2.5.3. | | |
| Collection | Bottom | Bottom | Removal | | |
| of tablet | shell | shell with | of the | | |
| pushed out | | designed | tapered | tablet by | |
| | as for 6P | compartment | suction | | |

Basic functions

3. Programing

| | | | | | | | |
|---|---|---|---|---|---|---|---|
| 3.1. | 3.1.1. | 3.1.2 | 3.1.3 | | | | |
| Patient- | Control | Touch- | Voice | | | | |
| controlled | buttons | screen | recog- | | | | |
| input of | nition | | | | | | |
| information | | | | | | | |
| 3.2. | 3.2.1. | 3.2.2. | 3.2.3. | 3.2.4. | 3.2.5. | 3.2.6. | 3.2.7. |
| Supply of | USB | Parallel | Serial | Firewire | Bluetooth | Infrared | PCI |
| programs by | interface | interface | interface | interface | | | |
| external | | | | | | | |
| devices | | | | | | | |
| Basic functions | | | | | | | |
| 3.3. | 3.3.1. | 3.3.2 | 3.3.3. | 3.3.4. | | | |
| Storage of | RAM | FLASH memory | EEPROM | Use of | | | |
| removal | external | | | | | | |
| times | memory | | | | | | |
| | plug-in | | | | | | |
| | cards | | | | | | |
| 3.4 | 3.4.1. | 3.4.2. | 3.4.3. | | | | |
| Micro- | Fairchild | Microchip | Cygnal | | | | |
| controller | semicon- | Technologies | C8051F305 | | | | |
| | ductor | PIC12LCE519 | | | | | |
| | ACE 1001L | | | | | | |
| 3.5. | 3.5.2. | 3.5.3 | 3.5.3 | | | | |
| Locking of | Software | Demounting | Sealable | | | | |
| manual | control- | of button | protect- | | | | |
| control | led | module | tive | | | | |
| part | cover | | | | | | |
| | above | | | | | | |
| | the | | | | | | |
| | buttons | | | | | | |

Basic functions

4. Alarm function
4.1.

| | | | | | |
|---|---|---|---|---|---|
| Alarm | 4.1.1. | | | | |
| triggering | Software- | | | | |
| controlled | | | | | |
| 4.2. | | | | | |
| Sound | 4.2.1 | 4.2.2. | 4.2.3. | | |
| generation | Piezoelec | Active | Passive | | |
| tric | boxes | boxes | | | |
| bleeper | | | | | |
| 4.3 | | | | | |
| Alarm | 4.3.1. | 4.3.2. | 4.3.3. | 4.3.4. | 4.3.5. |
| acknowledge- | Metal | When | Light | Weight | Pressure |
| ment | contact | opening | barrier | measure- | sensor |
| from the | the | in the | ment | in the | |
| buttons | removal | bottom | button | | |
| compart- | shell | | | | |

ment

Basic functions

5. Power supply
5.1.

| | | | | | |
|---|---|---|---|---|---|
| Power | 5.1.1. | 5.1.2. | 5.1.3. | 5.1.4. | 5.1.5. |
| source | Battery | Storage | Charging | Solar | Manual |
| (miniature) | battery | by | power | charging | |
| movement | by | | | | |
| (Swatch | dynamo | | | | |
| principle) | | | | | |
| 5.2. | | | | | |
| Low battery | 5.2.1. | 5.2.2 | | | |
| warning | By means of | Separate | | | |
| function | micro- | voltage | | | |
| controller | sensor | | | | |
| 5.3. | | | | | |
| Data | 5.3.1. | 5.3.2. | 5.3.3. | | |
| storage | Capacitor EEPROM | FLASH | | | |

upon change
of battery

Basic functions

6. Time function
6.1.

| | | | | |
|---|---|---|---|---|
| Time | 6.1.1. | 6.1.2. | 6.1.3. | 6.1.4. |
| measurement | Using the | Commer- | Alarm | Micro- |
| microcon- | cially | clock | controller | |
| troller's | available | module | + radio | |
| timer | alarm | with radio | control | |
| clock | control | | | |
| module | | | | |
| 6.2. | | | | |
| Time | 6.2.1. | 6.2.2. | | |
| display | Pixel- | Normal | | |
| based LCD | LCD | | | |
| display | display | | | |

(as for
alarm

Additional functions

7. Incorporation of additional electrical devices
7.1.

| | | | | | |
|---|---|---|---|---|---|
| Mobile | 7.1.1. | 7.1.2. | 7.1.3. | 7.1.4. | 7.1.5. |
| telephones GSM | GPRS | UMTS | TDMA | PDC | |
| (standard) | | | | | |
| 7.2 | | | | | |
| Mobile | 7.2.1. | 7.2.1 | | | |
| telephones | Piall rear | Incorpor- | | | |
| (fitted) | ation in | | | | |
| the top | | | | | |
| shell | | | | | |
| (use of | | | | | |
| the | | | | | |
| button | | | | | |
| 7.3 | | | | | |
| Music | 7.3.1. | 7.3.2. | 7.3.4. | 7.3.5 | |
| playback | CD player | Radio | MP-3 | Cassette | |
| recorder | | | | | |
| 7.4. | | | | | |
| Games | 7.1.1. | 7.4.2. | 7.4.3 | | |
| (pixel- | Tetris | Tamagotchi | Pacman | | |
| based | | | | | |
| display) | | | | | |
| 7.5 | | | | | |
| Additional | 7.5.1. | 7.5.2. | | | |
| lighting | Light | Internal | Laser | Pocket | |
| components | bulb on | lighting | pointer | lamp | |
| the | plugged | plugged | | | |
| outside | on the | on the | | | |
| outside | outside | | | | |
| 7.6. | | | | | |
| Camera | 7.6.1. | | | | |
| Digicams, | | | | | |
| e.g. | | | | | |
| similar to | | | | | |
| Benq DC 300 | | | | | |
| mini | | | | | |
| 7.7 | | | | | |
| Voice | 7.7.1. | 7.7.2 | | | |
| recording | Winbond | Comedia | | | |
| electronics | A930101 | | | | |
| ChipCorder | | | | | |
| I5216 | | | | | |
| 7.8 | | | | | |
| Emergency | 7.8.1. | 7.8.2. | 7.8.3. | | |
| bleeper | GPS | Glonass | Differ- | | |
| with | position | position | ential | | |
| position | finding | finding | GPS (e.g. | | |
| finding | (e.g. | Garmin | | | |
| Laipac TF10 | GPS 25 | | | | |
| OEM) | LP) | | | | |

Additional functions

8. Incorporation of other functions
8.1.

| | | | |
|---|---|---|---|
| Design | 8.1.1. | 8.1.2. | 8.1.3. |
| applications | With | Plugged | Bonded |
| magnetic | on | on | |
| 8.2. | | | |
| Keeping of | 8.2.1. | 8.2.2. | 8.2.3. |
| money, | Above the | Material | Separate |
| visiting | buttons | pocket | compart- |
| cards | inside the | on the | ment in |
| hinged lid | outside | the | |
| housing | | | |
| 8.3. | | | |
| Stand | 8.3.1. | 8.3.2. | 8.3.3. |
| On the | External | External | |
| device | stand | stand | |
| without | with | | |
| charger | charger | | |
| 8.4. | | | |
| Lighter | 8.4.1. | 8.4.2. | |
| Removable | Integrated | | |
| gas lighter | gas lighter | | |
| 8.5. | | | |
| Ballpoint | 8.5.1. | 8.5.2. | |
| pen | Plugged on | Inside the | |
| the side | device | | |
| (compartment | | | |
| in the lid) | | | |
| 8.6. | | | |
| Weather | 8.6.1. | 8.6.2. | 8.6.3. |
| station | Mechanical | Electronic, | Electronic |
| (cannot be | similar to | with data | |
| implemented | Jumbo JMR 838 | logger | |
| on account | WF E 55164 | | |

of space
problems)

1. An apparatus (1, 1′) for dispensing tablets, also in the form of pills, dragees or the like, having means for holding a blister pack (20), means for pushing out a tablet (21) from the blister pack and also means for setting taking times and means for displaying taking times, wherein the apparatus (1, 1′) has a bottom part (11, 101) and a lid (12, 102), removably connected to the bottom part (11), for holding the blister pack (20) and also having means (18, 43) for pushing out the tablets (21) from the blister pack (20), the arrangement of the means (18, 41) being matched to the arrangement of the tablets (21) in the blister pack (20) which is to be held.

2. The apparatus as claimed in claim 1, wherein the lid (12, 102) has recesses (13, 41) having centered holes (14, 42) which hold pushbuttons (18, 43) such that they cannot be lost.

3. The apparatus as claimed in claim 1, wherein the bottom part (11) has at least one support (15).

4. The apparatus as claimed in claim 1, wherein a grid or mesh (16) having holes (17) whose arrangement corresponds to the arrangement of the means (18, 43) is provided.

5. The apparatus as claimed in claim 4, wherein the grid or mesh (16) is provided in the bottom part (11, 101).

6. The apparatus as claimed in claim 4, wherein the grid or mesh (16) is provided in the lid (12, 102).

7. The apparatus as claimed in claim 1, wherein the bottom part (11, 101) has a dispensing chute (11′) and a dispensing opening (11″).

8. The apparatus as claimed in claim 1, wherein the means (18, 43) have at least one lamp element (43′, 43″).

9. The apparatus as claimed in claim 1, wherein the means (18, 43) are made of a transparent, optically conductive plastic.

10. The apparatus as claimed in claim 1, wherein the bottom part (11, 101) or the lid (12, 102) has a display device (103), preferably an LCD display or LED display, and also at least one programming and/or display button (104, 104′, 105, 105′).

11. The apparatus as claimed in claim 1, wherein the inside of the lid (12, 102) is provided with a board (30) having holes whose arrangement corresponds to the arrangement of the means (18, 43).

12. The apparatus as claimed in claim 11, wherein the board (30) is provided for programming the taking cycle for the tablets (21) and for acknowledging tablet removal.

13. The apparatus as claimed in claim 11, wherein the board (30) is provided just for acknowledging tablet removal, and the bottom part (11) contains a further board for programming the taking cycle for the tablets (21), the two boards being in electrical contact with one another.

14. A lid (12, 102) for an apparatus as claimed in claim 1, wherein it is provided for holding the blister pack (20) and has means (18, 43) for pushing out the tablets (21) from the blister pack (20), the arrangement of the means (18, 41) being matched to the arrangement of the tablets (21) in the blister pack (20) which is to be held.

15. The lid as claimed in claim 14, wherein it has recesses (13, 41) having centered holes (14, 42) which hold pushbuttons (18, 43) such that they cannot be lost.

16. The lid as claimed in claim 14, wherein a grid or mesh (16) having holes (17) whose arrangement corresponds to the arrangement of the means (18, 43) is provided.

17. The lid as claimed in claim 14, wherein the means (18, 43) have at least one lamp element (43′, 43″).

18. The lid as claimed in claim 14, wherein the means (18, 43) are made of a transparent, optically conductive plastic.

19. The lid as claimed in claim 14, wherein its inside is provided with a board (30) having holes whose arrangement corresponds to the arrangement of the means (18, 43).

20. The lid as claimed in claim 19, wherein the board (30) is provided for programming the taking cycle for the tablets (21) and for acknowledging tablet removal.

21. The lid as claimed in claim 19, wherein the board (30) is provided just for acknowledging tablet removal.

22. The lid as claimed in claim 14, wherein it has a display device (103), preferably an LCD display, and also at least one programming and/or display button (104, 104′, 105, 105′).

23. A bottom part for an apparatus as claimed in claim 1, wherein a grid or mesh (16) having holes (17) whose arrangement corresponds to the arrangement of the means (18, 43) is provided.

24. The bottom part as claimed in claim 23, wherein it has a dispensing chute (11′) and a dispensing opening (11″).

25. The bottom part as claimed in claim 23, wherein it has a display device (103), preferably an LCD display, and also at least one programming and/or display button (104, 104′, 105, 105′).

26. The bottom part as claimed in one of claims 23 to 25, wherein it has a board for programming the taking cycle for the tablets (21).
